(19) United States
(12) Patent Application Publication
(10) Pub. No.: US 2018/0069898 A1
(43) Pub. Date: Mar. 8, 2018

(54) Methods and Systems for Managing Carrier Configurations in a Zero-Rated System

(71) Applicant: FACEBOOK, INC., Menlo Park, CA (US)

(72) Inventors: Filippo Pacifici, San Francisco, CA (US); Artem Pasyechnyk, San Francisco, CA (US); Omri David Shaked, Sunnyvale, CA (US); Xin Wang, Sunnyvale, CA (US)

(21) Appl. No.: 15/260,159

(22) Filed: Sep. 8, 2016

(51) Int. Cl. H04L 29/06; G06Q 20/12

(52) U.S. Cl. CPC H04L 63/20; H04L 63/102; G06Q 20/127

(57) ABSTRACT

A request by a user device for accessing content in a first web-based product is received from a first network carrier. An identity of the first network carrier is determined from the received request. Based at least in part on the identity of the first network carrier, one or more sets of access rules associated with the first network carrier are obtained. Each of the one or more sets of access rules specifies pricing policies for each of one or more content types. Based on the one or more sets of access rules, access to the requested content is granted or denied. A link is generated in accordance with the one or more sets of access rules and the access being granted or denied, and the generated link is transmitted to the first network carrier

### TECHNICAL FIELD

This relates generally to network communications, including but not limited to granting or denying access to content based on access rules for network carriers.

### BACKGROUND

Mobile devices have become an increasingly dominant means through which consumers access, download, and consume electronic content over the Internet. Despite substantial advancements in telecommunications technology, however, affordable access to the Internet remains relatively low. Considering the limited affordability of Internet access in certain geographic regions, such as developing countries, consumers often have difficulty accessing the Internet and therefore are often left frustrated when using mobile devices.

Recently, free Internet services have become an increasingly popular option to improve the affordability of Internet access. These free Internet services are called “zero-rated” Internet services. In some zero-rated systems, different network carriers may offer access to content through services and products based on different pricing policies.

### SUMMARY

Accordingly, there is a need for methods and systems for identifying and using access rules for network carriers to grant or deny access to content in accordance with eligible pricing policies. Access rules associated with different network carriers are maintained, specifying pricing policies for different content types, such as images or video. In response to receiving access requests from network carriers, associated access rules are obtained and used to determine whether access to content in accordance with a particular pricing policy is granted or denied. By doing so, systems are able to efficiently provide users access to content in accordance with eligible pricing policies.

In accordance with some embodiments, a method is performed at a server system having one or more processors and memory storing instructions for execution by the one or more processors. The method includes receiving, from a first network carrier, a request by a user device for accessing content in a first web-based product. An identity of the first network carrier is determined from the received request. Based at least in part on the identity of the first network carrier, one or more sets of access rules associated with the first network carrier are obtained. Each of the one or more sets of access rules specifies pricing policies for each of one or more content types. Based on the one or more sets of access rules, access to the requested content is granted or denied. A link is generated in accordance with the one or more sets of access rules and the access being granted or denied, and the generated link is transmitted to the first network carrier.

In accordance with some embodiments, a server system includes one or more processors, memory, and one or more programs; the one or more programs are stored in the memory and configured to be executed by the one or more processors. The one or more programs include instructions for performing the operations of the method described above. In accordance with some embodiments, a non-transitory computer-readable storage medium has stored therein instructions that, when executed by the server system, cause the server system to perform the operations of the method described above.

Thus, server systems are provided with more effective and efficient methods for granting or denying access to content, thereby increasing the effectiveness and efficiency of such systems and user satisfaction in connection with the systems.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating an exemplary network architecture, in accordance with some embodiments.

FIG. 2 is a block diagram illustrating an exemplary user device, in accordance with some embodiments.

FIG. 3 is a block diagram illustrating an exemplary server system, in accordance with some embodiments.

FIG. 4 is a block diagram illustrating elements of an exemplary server system, in accordance with some embodiments.

FIGS. 5A-5C are flow diagrams illustrating a method of identifying and using access rules for network carriers to grant or deny access to content in accordance with eligible pricing policies, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first network carrier could be termed a second network carrier, and, similarly, a second network carrier could be termed a first network carrier, without departing from the scope of the various described embodiments. The first network carrier and the second network carrier are both network carriers, but they are not the same network carrier.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

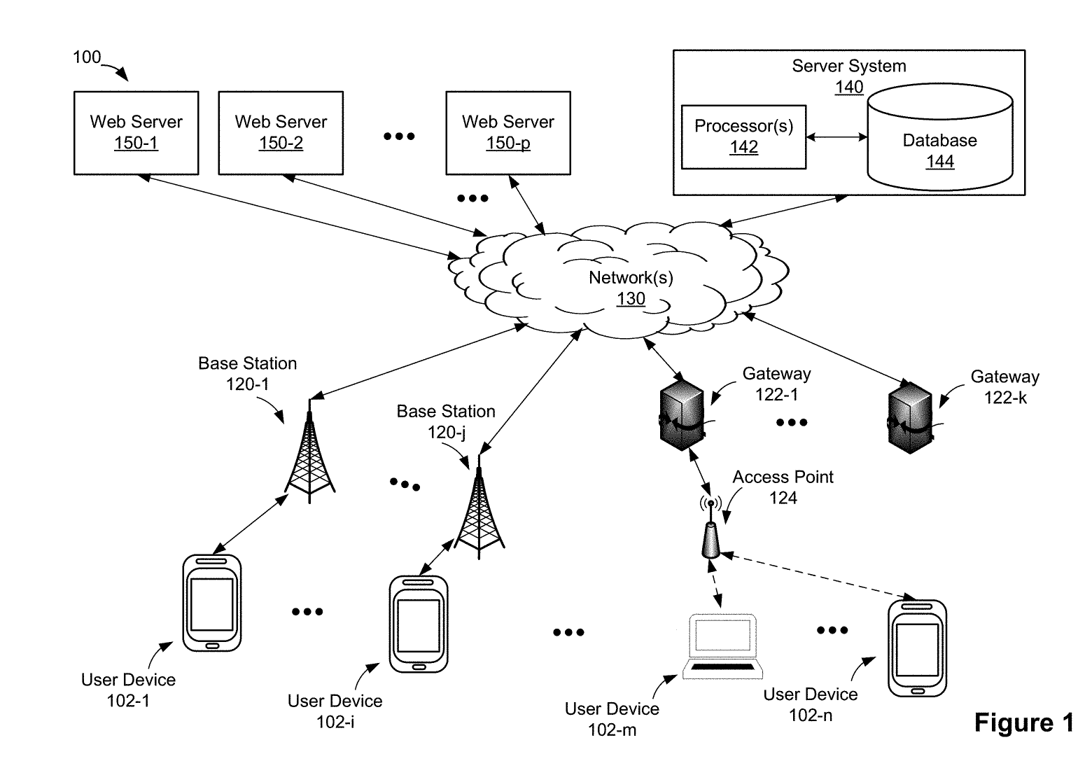

FIG. 1 illustrates a network architecture 100 in accordance with some embodiments. The network architecture 100 allows mobile/network carriers (and/or network providers) to provide one or more subscribers (e.g., users) Internet service with one or more pricing policies, e.g., for free (e.g., zero-rated), at special pricing (e.g., discounted), or at regular pricing. For example, a mobile carrier assigns respective pricing policies to IP addresses, domain names (e.g., domain addresses, host names, host addresses, URLs), services, and/or web-based products associated with one or more web servers which provide Internet content to subscribers. The creation of the pricing policies also takes into consideration subscriber account types (e.g., pre-paid, an account having zero balance, etc.), subscriber phone numbers, subscriber IP addresses, requested content types, applications running on subscriber devices, and/or other device features.

The network architecture 100 routes the traffic between one or more subscriber devices and destination IP addresses using predetermined pricing policies (e.g., free, special pricing, or regular pricing). The network architecture 100 thus provides various products and/or functionalities (e.g., a Free Basics user interface for zero-rated content) to subscribers.

In some embodiments, a subscriber device can access one or more pre-determined IP addresses or one or more pre-determined domain names at predetermined pricing policies. For example, for zero-rated service, a subscriber device can download, upload, and/or view a webpage or use an application (e.g., a web-based product) associated with a predetermined IP address or a predetermined domain name for free, without being charged for network access. Thus these types of predetermined IP addresses or domain names are called zero-rated content providers. The content from zero-rated web pages and/or applications is called zero-rated content.

In another example, for regularly priced services, a subscriber device can access one or more pre-determined IP addresses or one or more predetermined domain names that are not zero-rated by paying service fees. These IP addresses or domain names that require paid network access are called non-zero-rated content providers (e.g., regular-priced content providers), and the content provided by the non-zero-rated content providers is called non-zero-rated content (e.g., regular-priced content).

In yet another example, for specially priced services, a network operator may provide promotions, such as discounted pricing, for accessing certain IP addresses or certain domain names, and/or certain content types from certain IP addresses or certain domain names. The specially priced services may be provided to certain subscribers as selected by the network operator.

Content (e.g., zero-rated, non-zero-rated, discounted, etc.) may be content of one or more content types, including but not limited to text (e.g., a social media post), images, video, audio (e.g., Voice over IP (VoIP)), and/or any other types or categories of transmitted data.

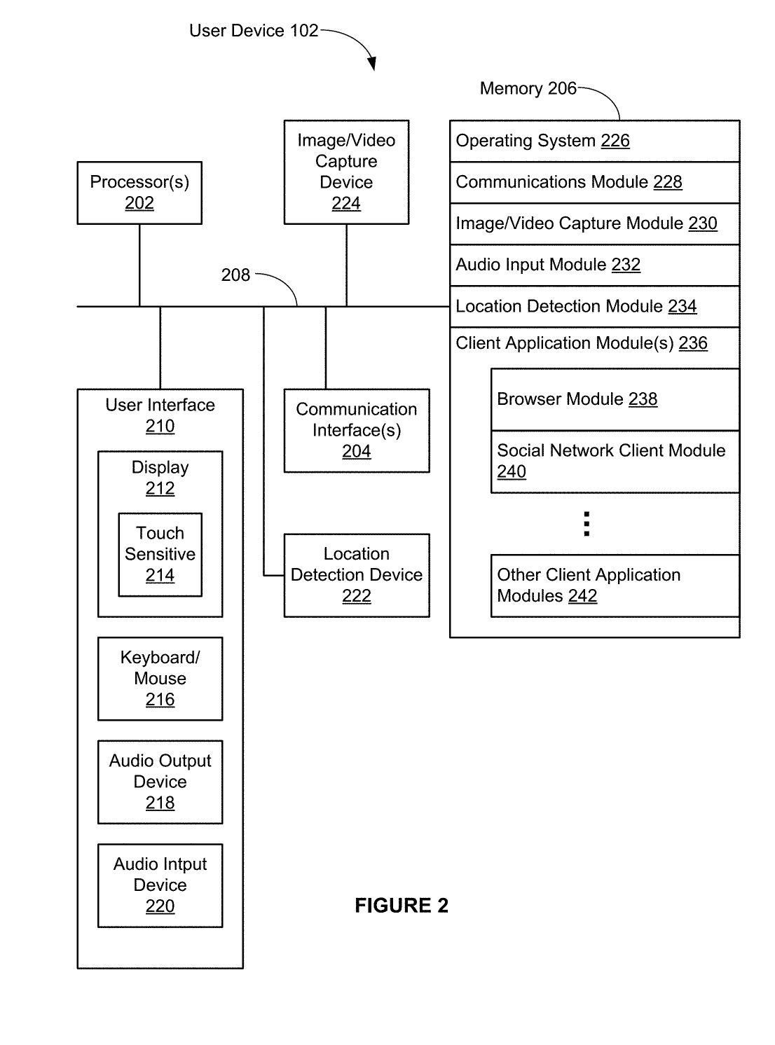

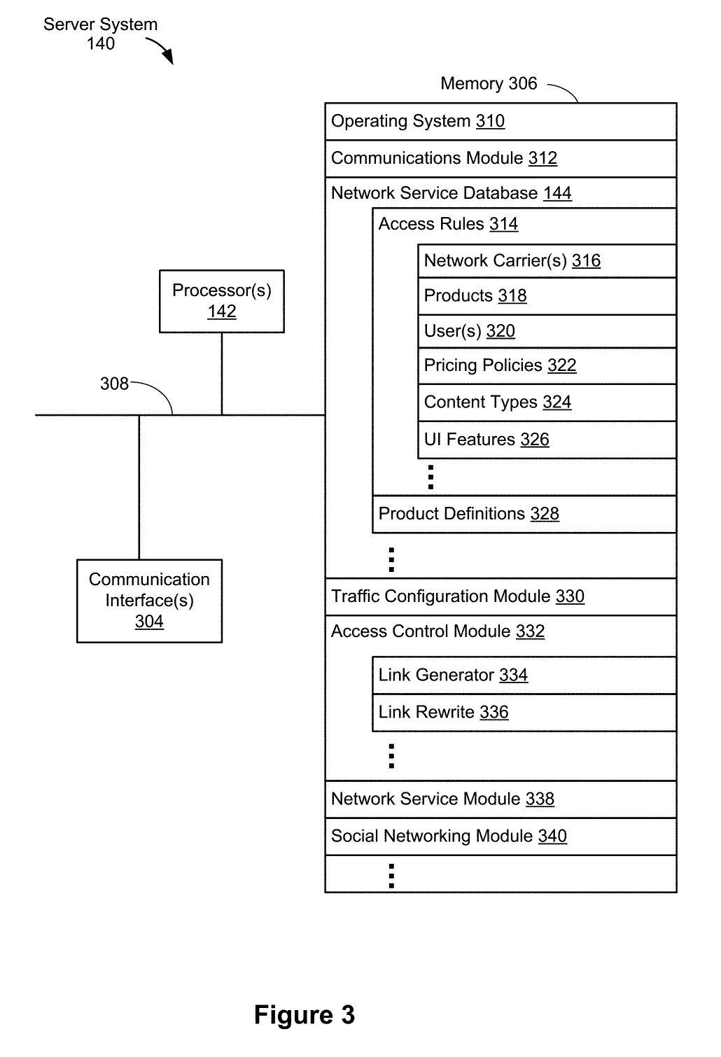

The network architecture 100 includes client-side modules (e.g., as discussed with reference to FIG. 2) executed on a number of user devices (also called “client devices,” “client systems,” “client computers,” “subscriber devices,” or “clients”) 102-1 . . . 102-i . . . 102-m . . . 102-n and server-side modules (e.g., as discussed with reference to FIG. 3) executed on one or more server systems, such as a server system 140 and/or one or more web servers 150-1, 150-2 . . . 150-p. The user devices 102 communicate with the server systems (e.g., the server system 140 and/or the one or more web servers 150) through one or more networks 130 (e.g., the Internet, cellular telephone networks, mobile data networks, other wide area networks, local area networks, metropolitan area networks, and so on). Client-side modules provide client-side functionalities for accessing the network service platform (e.g., zero-rated Internet service, special priced Internet service, and regular priced Internet service). Server-side modules provide server-side functionalities for the network service platform (e.g., routing network traffic, serving internet content with specific pricing policies, and/or managing user account information) for any number of user devices 102.

In some embodiments, the user devices 102 are mobile devices and/or fixed-location devices. The user devices 102 are associated with subscribers (not shown) who employ the user devices 102 to access one or more IP addresses or domain names (e.g., including zero-rated content providers and/or non-zero-rated content providers). The user devices 102 execute web browser applications and/or other applications that can be used to access the one or more IP addresses or domain names. In some embodiments, a user device 102 processes requests for network services and forwards the requests from the user device 102 to the server system 140 (e.g., via a network carrier). The requests for network services include, but are not limited to, one or more Domain Name System (DNS) requests and one or more Transmission Control Protocol (TCP) requests.

Examples of the user devices 102 include, but are not limited to, feature phones, smart phones, smart watches, personal digital assistants, portable media players, tablet computers, 2D gaming devices, 3D (e.g., virtual reality) gaming devices, laptop computers, desktop computers, televisions with one or more processors embedded therein or coupled thereto, in-vehicle information systems (e.g., an in-car computer system that provides navigation, entertainment, and/or other information), wearable computing devices, personal digital assistants (PDAs), enhanced general packet radio service (EGPRS) mobile phones, media players, navigation devices, game consoles, smart televisions, remote controls, combinations of any two or more of these data processing devices or other data processing devices, and/or other appropriate computing devices that can be used to communicate with the server system 140.

In some embodiments, the network architecture 100 includes one or more base stations 120-1 . . . 120-j for carrier networks that provide cellular/wireless service to the user devices 102. One or more network operators (e.g., network service providers, network carriers, or cellular companies) own or control the one or more base stations 120 and related infrastructure. For example, the base station 120 communicably connects one or more user devices 102 (e.g., 102-1) to one another (e.g., 102-i) and/or to the networks 130. In some embodiments, the network architecture 100 includes one or more gateways 122-1 . . . 122-k connected to one or more wireless access points 124-1 . . . 124-q respectively for providing Wi-Fi networks to the user devices 102 (e.g., 102-m, 102-n). The base stations 120 and the gateways 122 are responsible for routing traffic between the networks 130 and the user device 102.

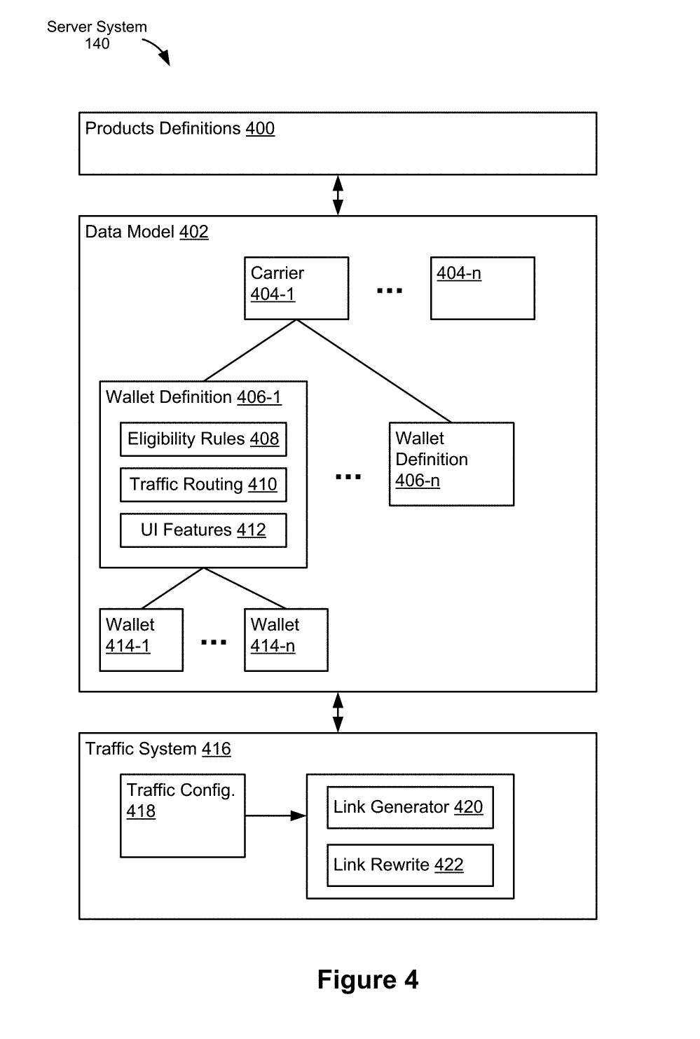

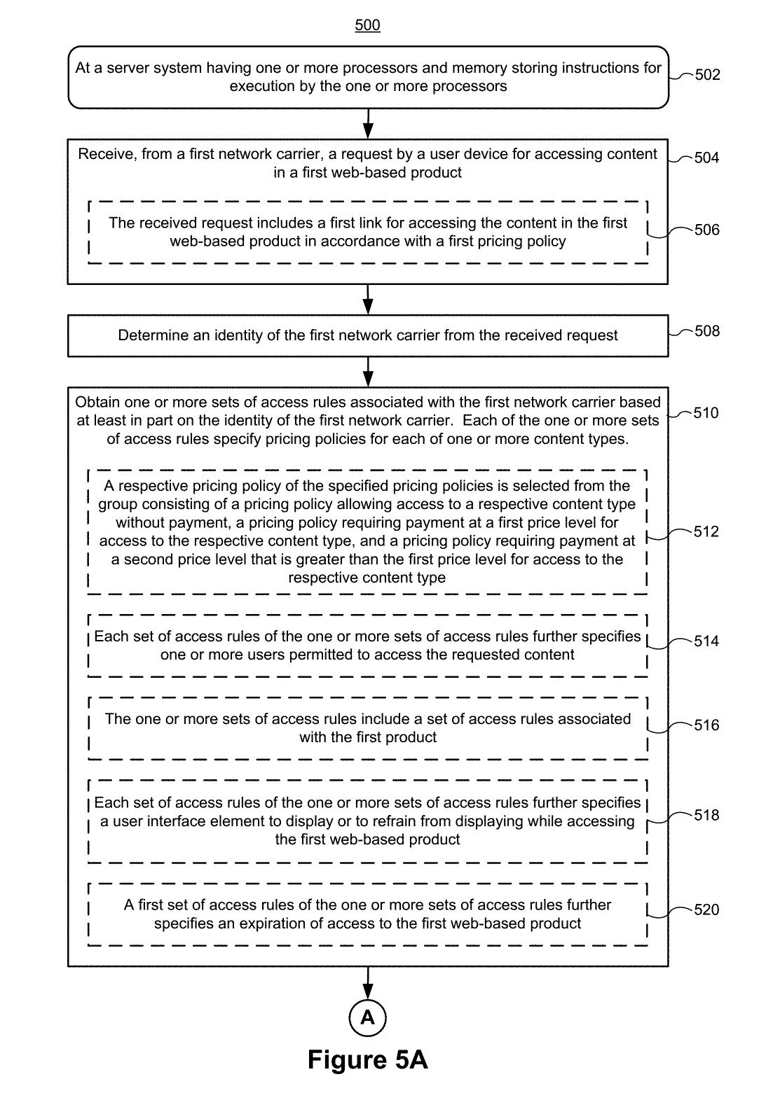

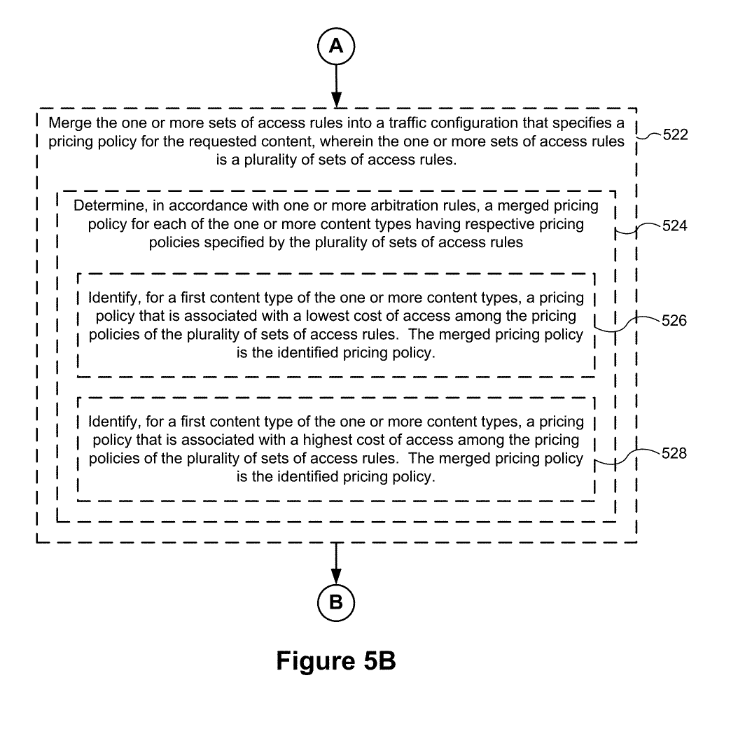

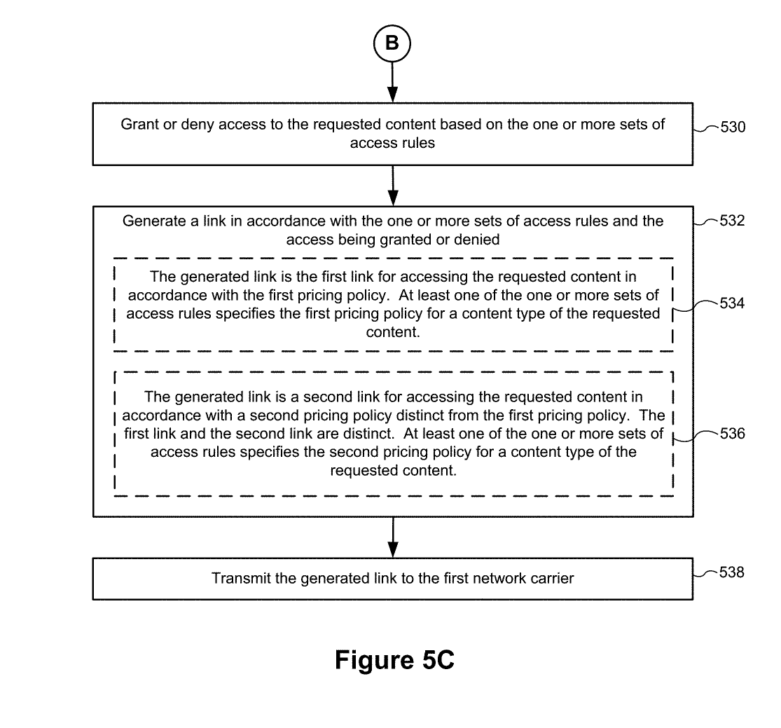

In some embodiments, the server system 140 is implemented on one or more standalone computers or a distributed network of computers. In some embodiments, the server system 140 also employs various virtual devices and/or services of third party service providers (e.g., cloud computing) to provide the underlying computing resources and/or infrastructure resources of the server system 140. The server system 140 includes one or more processing units (e.g., processors 142 or cores) and one or more databases 144. In some embodiments, the server system 140 processes requests from user devices 102 for accessing content in web-based products. The requests are received from network carriers associated with the user devices 102. Sets of access rules associated with the network carriers are obtained, the sets of access rules specifying pricing policies for accessing different types of content via respective network carriers (e.g., mappings between content types and associated pricing, such as free or paid). Based on obtained sets of access rules, the server system 140 grants or denies access to requested content in accordance with a particular pricing policy (indicated by the received request, such as a URL specifically for accessing free content). A link is generated accordingly and transmitted to the network carrier, after which requested access to the content in accordance with the particular pricing policy is either granted or denied to the requesting user devices 102 via the generated link. The database 144 stores various information, including but not limited to information related to subscribers, information related to network operators, and/or access rules specifying pricing policies for different content types. Identifying and using access rules for network carriers to grant or deny access to content in accordance with eligible pricing policies is described in greater detail with respect to FIGS. 4 and 5A-5C.

In some embodiments, the one or more web servers 150-1, 150-2 . . . 150-p include social networking servers configured to host various social networking functionalities. In some embodiments, the one or more web servers 150-1, 150-2 . . . 150-p include third-party servers configured to provide other types of services. In some embodiments, the one or more web servers 150 host or provide access to content in connection with services or in web-based products that include various content types (e.g., text, images, video, audio, etc.). Exemplary third-party services and/or web-based products include books, business, communication (e.g., text/video messaging applications), contests, education, entertainment, fashion, finance, food and drink, games, health and fitness, lifestyle, local information, movies, television, music and audio, news, photos, video, productivity, reference material, security, shopping, sports, travel, utilities, social networking (e.g., applications for accessing a social network service), and the like. In some embodiments, a given web server 150 hosts a website that provides web pages to user devices 102. Alternatively or additionally, a given web server 150 hosts an application that is used by user devices 102. As discussed above, the server system 140 may route or redirect requests from user devices 102 to respective web servers 150. In some embodiments, the server system 140 uses inline frames (“iframes”) to nest independent websites within a web page (e.g., a zero-rated, a regular-priced, or a special-priced web page). In some embodiments, the server system 140 uses iframes to enable third-party developers to create applications that are hosted separately by a web server 150 (e.g., a third-party server), but operate within a user session and are accessed through the user's profile in the server system 140. In some embodiments, a given web server 150 is used to provide third-party content (e.g., news articles, reviews, message feeds, etc.). In some embodiments, a given web server 150 is a single computing device, while in other embodiments, a given web server 150 is implemented by multiple computing devices working together to perform the actions of a server system (e.g., cloud computing).

In some embodiments, respective IP addresses or respective domain names associated with one or more web servers 150 are predetermined to be associated with zero-rated content providers and are configured to provide zero-rated content to the user devices 102. A user device 102 does not need to pay data usage fees to a network provider for viewing, downloading, and/or uploading data to the one or more zero-rated content providers. In some embodiments, respective IP addresses or respective domain names associated with one or more web servers 150 are associated with non-zero-rated content providers (e.g., regular-priced or special-priced) and provide non-zero-rated (e.g., paid) content. A user device 102 pays a data usage fee to a network provider for viewing, downloading, and/or uploading data to the one or more non-zero-rated content providers. In some embodiments, respective IP addresses or respective domain names associated with one or more web servers 150 are associated with both zero-rated content providers and non-zero rated content providers, and are therefore configured to provide both zero-rated (e.g., free) content and non-zero-rated (e.g., paid) content to the user devices 102.

FIG. 2 is a block diagram illustrating an exemplary user device 102 in accordance with some embodiments. The user device 102 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The user device 102 includes a user interface 210. The user interface 210 typically includes a display device 212. In some embodiments, the user device 102 includes inputs such as a keyboard, mouse, and/or other input buttons 216. Alternatively or in addition, in some embodiments, the display device 212 includes a touch-sensitive surface 214, in which case the display device 212 is a touch-sensitive display. In client devices that have a touch-sensitive display 212, a physical keyboard is optional (e.g., a soft keyboard may be displayed when keyboard entry is needed). The user interface 210 also includes an audio output device 218, such as speakers or an audio output connection connected to speakers, earphones, or headphones. Furthermore, some client devices 104 use a microphone and voice recognition to supplement or replace the keyboard. Optionally, the user device 102 includes an audio input device 220 (e.g., a microphone) to capture audio (e.g., speech from a user). Optionally, the user device 102 includes a location detection device 222, such as a GPS (global positioning satellite) or other geo-location receiver, for determining the location of the user device 102. The user device 102 also optionally includes an image/video capture device 224, such as a camera or webcam.

Memory 206 includes high-speed random-access memory, such as DRAM, SRAM, DDR RAM or other random-access solid-state memory devices; and may include non-volatile memory, such as one or more magnetic disk storage devices, optical disk storage devices, flash memory devices, or other non-volatile solid-state storage devices. Memory 206 may optionally include one or more storage devices remotely located from the processor(s) 202. Memory 206, or alternately the non-volatile memory device(s) within memory 206, includes a non-transitory computer-readable storage medium. In some embodiments, memory 206 or the computer-readable storage medium of memory 206 stores the following programs, modules and data structures, or a subset or superset thereof:
an operating system 226 that includes procedures for handling various basic system services and for performing hardware dependent tasks;
a network communication module 228 that is used for connecting the user device 102 to other computers via the one or more communication network interfaces 204 (wired or wireless) and one or more communication networks, such as the Internet, cellular telephone networks, mobile data networks, other wide area networks, local area networks, metropolitan area networks, and so on;
an image/video capture module 230 (e.g., a camera module) for processing a respective image or video captured by the image/video capture device 224;
an audio input module 232 (e.g., a microphone module) for processing audio captured by the audio input device 220;
a location detection module 234 (e.g., a GPS, Wi-Fi, or hybrid positioning module) for determining the location of the user device 102 (e.g., using the location detection device 222) and providing this location information for use in various applications (e.g., social network client module 240); and
one or more client application modules 236, including the following modules (or sets of instructions), or a subset or superset thereof:
   a web browser module 238 (e.g., Edge or Internet Explorer by Microsoft, Firefox or Nightly by Mozilla, Safari by Apple, or Chrome by Google) for accessing, viewing, and interacting with web sites (e.g., zero-rated and/or non-zero-rated content provided by a web server 150-1, FIG. 1),
   a social network module 240 for providing an interface for accessing content (e.g., zero-rated content, non-zero-rated content, etc.) and related features provided by a social-networking service (e.g., a social-networking service provided by a web server 150-1); and/or
   other optional client application modules 242, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

FIG. 3 is a block diagram illustrating an exemplary server system 140 in accordance with some embodiments. The server system 140 includes one or more processing units (processors or cores) 142, one or more network or other communications interfaces 304, memory 306, and one or more communication buses 308 for interconnecting these components. The communication buses 308 optionally include circuitry (sometimes called a chipset) that interconnects and controls communications between system components. The server system 140 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 306 may optionally include one or more storage devices remotely located from the processor(s) 142. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 310 that includes procedures for handling various basic system services and for performing hardware dependent tasks;
a network communication module 312 that is used for connecting the server system 140 to other computers via the one or more communication network interfaces 304 (wired or wireless) and one or more communication networks (e.g., the one or more networks 130);
a network service database 144 for storing data associated with a network service platform, which includes:
   access rules 314 storing one or more sets of access rules, where a respective set of access rules specifies:
      network carrier(s) 316 (e.g., network carriers 404-1 through 404-n, FIG. 4) associated with the respective set of access rules;
      products 318 (e.g., services, web-based products, etc.) that users specified by the respective set of access rules are eligible or ineligible to access;
      user(s) 320 of the associated network carrier(s) 316 that are eligible or ineligible to access products 318;
      pricing policies 322 (e.g., free, paid, etc.) for content types accessed through or in connection with products 318;
      content types 324 (e.g., text, images, video, audio, etc.) accessed through or in connection with products 318; and
      user interface features 326, specifying user interface elements displayed in response to user access requests being granted or denied (e.g., interstitial image when attempting to access paid content); and
   product definitions 328 specifying one or more content types (e.g., text, images, video, audio, etc.) associated with various services or web-based products (e.g., hosted by one or more web servers 150 and accessible via networks 130, FIG. 1);
a traffic configuration module 330 for merging access rules 314 (e.g., in accordance with predefined arbitration rules) into a traffic configuration (e.g., traffic configuration 418, FIG. 4);
an access control module 332 for handling and responding to requests by user devices 102, and for granting or denying access to requested content based on access rules 314; including:
   a link generator module 334 for generating links in accordance with access rules 314 and access to content (in accordance with a particular pricing policy) being granted or denied; and
   a link rewrite module 336 for rewriting links (included in received access requests) in accordance with access rules 314 and carrier-specific configuration parameters;
a network service module 338 for providing network service (e.g., Free Basics service) with various pricing policies and related features; and
a social networking module 340 for providing social-networking services and related features.

In some embodiments, the network service module 376 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), Python, and the like.

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

FIG. 4 is a block diagram illustrating elements of a server system 140, in accordance with some embodiments. The elements illustrated in FIG. 4 represent various data structures, modules for performing steps of the method 500 (described with respect to FIGS. 5A through 5C), or groupings thereof. The server system 140 described in FIG. 4 represents an exemplary configuration of elements, and other embodiments of the server system 140 may include fewer or additional elements, or different logical groupings thereof.

In the example shown, the server system 140 (e.g., server system 140, FIG. 1) comprises product definitions 400, a data model 402, and a traffic system 416.

Product definitions 400 include one or more data structures that specify one or more content types (e.g., text, images, video, audio, etc.) associated with various services or web-based products (e.g., hosted by one or more web servers 150 and accessible via networks 130, FIG. 1). As previously described, content accessible via the services or web-based products may include zero-rated (e.g., free) or non-zero rated (e.g., paid) content.

Data model 402 is a multi-tenant configuration that maintains one or more data structures that collectively define pricing policies for accessing content for subscribers of network carriers. Network carriers 404-1 through 404-n may be associated with one or more respective wallet definitions 406-1 through 406-n (e.g., access rules 314 for networks carriers 316, FIG. 3). Each wallet definition 406 includes eligibility rules 408 that specify which users of a respective network carrier are eligible (or ineligible) to access content (or particular content types) in connection with particular services or in web-based products in accordance with specified pricing policies. Groups of users (e.g., users 320, FIG. 3) specified by the eligibility rules 408 may be defined with varying levels of specificity. For example, groups of users may be defined based on characteristics of users requesting access or devices associated with received access requests. User characteristics may include user account information (e.g., demographic information) or subscription details for a service, web-based product, or network carrier associated with the access requests (e.g., users who are subscribers of a network carrier for less than a predefined period of time, such as new users having subscriber accounts for less than a month). Device characteristics may include a platform of an associated device (e.g., operating system), a version of a web-based product or application, or any other software/hardware-based device specifications.

Wallet definitions 406 further include traffic routing rules 410 that specify pricing policies for content types accessed through different services or web-based products (e.g., for access rules 314, mapping between pricing policies 322 and content types 324 for a network carrier 316, FIG. 3). As an example, a set of eligibility rules 408 defines a particular group of users to include subscribers of a network carrier who use a particular mobile device platform (e.g., Android), and traffic routing rules 410 specify that image content (excluding video) from a particular website (e.g., hosted by web server 105-1) is accessible free of charge (i.e., zero-rated) by users of the defined group. In this example, the traffic routing rules 410 may further specify that video content from a different website (e.g., hosted by web server 105-2) requires payment for access (i.e., non-zero-rated) by users of the defined group.

In some embodiments, a wallet definition 406 includes respective user interface features 412 that specify user interface elements displayed (or not displayed) in response to user access requests being granted or denied (based on eligibility rules 408, traffic routing rules 410, etc. of wallet definitions 406). For example, in response to requesting access to paid content (i.e., content requiring payment for access), an interstitial image is displayed in place of the requested content, indicating that payment is required in order to access the content. Optionally, one or more selectable affordances may also be displayed, selection of which may indicate that a user has agreed or declined to pay for access to the requested content.

Wallet definitions 406 may optionally include respective user-specific wallets 414 (e.g., 414-1 through 414-n) that specify for a particular user (or group of users that corresponds to a subset of eligible users defined by eligibility rules 408) requesting access: (1) an expiration of access (e.g., access to requested content is granted for a single day to the user, a limit of access to 10 images a day, etc.), and/or (2) access rules in addition or as an alternative to rules specified by an associated wallet definition. Users specified by user-specific wallets 414 may be identified by a username for a service or web-based product (e.g., social network service user ID) or any other user identifier (e.g., Mobile Station International Subscriber Directory Number (MSISDN) for network carrier).

In response to receiving a request to access content from a network carrier, the traffic system module 416 obtains from the data model 402 one or more wallet definitions 406 associated with the network carrier in order to determine whether access to the requested content in accordance with a particular pricing policy should be granted or denied. In some embodiments, the obtained one or more wallet definitions 406 are merged into a traffic configuration 418 in accordance with one or more arbitration rules, as described in greater detail with respect to the method 500 (e.g., content types having different specified pricing policies are resolved into a merged pricing policy).

Based on whether access to the requested content in accordance with the particular pricing policy is granted or denied, a corresponding link is generated by link generator 420 and transmitted to the network carrier. In one example, the traffic system module 416 receives from a network carrier a request for accessing content in accordance with a first pricing policy (e.g., a URL for accessing content without payment). However, an obtained wallet definition 406 indicates that users of the network carrier may only access content of that type in accordance with a different pricing policy (e.g., payment required to access non-zero-rated content). Accordingly, access to the requested content in accordance with the first pricing policy is denied, and a URL redirecting a user (e.g., to an alternative website where access to the content requires payment) is generated and transmitted to the network carrier (e.g., “paid.fb.com” is generated and replaces “free.fb.com,” a URL for accessing free content).

In some cases, content is accessed via native applications (e.g., social network client module 240, FIG. 2,)) that maintain a cache of URLs. Given pricing variations of the same products offered by different network carriers, URLs sometimes require modification when users switch network carriers in order to access content based on the correct pricing policy. Thus, in some embodiments, carrier-specific configuration parameters for modifying URLs are obtained before generating and providing network carriers with URLs for requested content. Using carrier-specific configuration parameters, URLs transmitted to network carriers are rewritten by link rewrite module 422 (e.g., re-write URL from “free.fb.com” to “paid.fb.com”) such that services are accessed in accordance with corresponding pricing policies.

FIGS. 5A-5C are flow diagrams illustrating method 500 of identifying and using access rules for network carriers to grant or deny access to content in accordance with eligible pricing policies, in accordance with some embodiments. The method 500 is performed (502) at a server system (e.g., server system 140, FIGS. 3 and 4) having one or more processing units (e.g., processors or cores) and memory storing instructions for execution by the one or more processors. FIGS. 5A-5C correspond to instructions stored in a computer memory (e.g., memory 306 of the server system 140, FIG. 3) or other computer-readable storage medium.

In performing the method 500, the server system receives (504), from a first network carrier, a request by a user device for access to content in a first web-based product. As an example, referring to FIG. 1, the request is by a user device 102-1 for access to video content hosted by a web server 150-1. In this example, the request is for access to the content using a web-based product stored on the user device 102-1 (e.g., social network client module 240, FIG. 2), where the web-based product is used to access content hosted by the web server 150-1. In this example, the first network carrier is associated with the base station 120-1.

In some embodiments, the received request includes (506) a first link for accessing the content in the first web-based product in accordance with a first pricing policy (e.g., “free.fb.com,” a URL for accessing video content without payment).

An identity of the first network carrier is determined (508) from the received request (e.g., identified from source IP address associated with the received request, HTTP header (if the carrier uses a proxy server), etc.). Additionally and/or alternatively, the identity of the first network carrier is specified in meta data or other data included in or transmitted with the received request.

One or more sets of access rules associated with the first network carrier are obtained (510) based at least in part on the identity of the first network carrier (e.g., wallet definitions 406-1 through 406-n for a network carrier 404-1, FIG. 4). Each of the one or more sets of access rules specify pricing policies for each of one or more content types (e.g., traffic routing rules 410 mapping content types to respective pricing policies).

In some embodiments, a respective pricing policy of the specified pricing policies is selected (512) from the group consisting of a pricing policy allowing access to a respective content type without payment (e.g., zero-rated content), a pricing policy requiring payment at a first price level for access to the respective content type (e.g., discounted, non-zero-rated content), and a pricing policy requiring payment at a second price level that is greater than the first price level for access to the respective content type (e.g., non-discounted, non-zero-rated content).

In some embodiments, each set of access rules of the one or more sets of access rules further specifies (514) one or more users permitted to access the requested content (e.g., eligibility rules 408, FIG. 4). Furthermore, in some embodiments, the one or more sets of access rules include a set of access rules specifying respective pricing policies for a single user (e.g., user-specific wallets 414, FIG. 4). In some embodiments, obtaining the one or more sets of access rules is further based on a characteristic of a user of the user device and/or a characteristic of the user device (e.g., new subscribers of the first network carrier). Referring to FIG. 4, for example, the server system 140 obtains corresponding wallet definitions 406 by identifying respective eligibility rules 408 that include an identified characteristic of a user associated with the user device. Examples of user and device characteristics are described with respect to FIG. 4.

In some embodiments, the one or more sets of access rules are associated with one or more services or web-based products (e.g., access rules for accessing content via a social network client module 240, FIG. 2), and obtaining the one or more sets of access rules is based on the first web-based product (through which access to the content is requested). In some implementations, the one or more sets of access rules include (516) a set of access rules associated with the first product.

In some embodiments, each set of access rules of the one or more sets of access rules further specifies (518) a user interface element to display or to refrain from displaying while accessing the first web-based product (e.g., user interface features 412, FIG. 4). In some implementations, the user interface element includes an image to display in response to an attempt to access a content type that requires payment (e.g., interstitial image). In some implementations, the user interface element includes a video banner.

In some embodiments, a first set of access rules of the one or more sets of access rules further specifies (520) an expiration of access to the first web-based product (or a content type of the requested content). The expiration of access may be time based (e.g., access permitted without payment for one week), an access quota (e.g., a number of times a content type may be accessed, an amount of data that may be accessed for a content type, etc.), and/or any other predefined limitation with respect to content access.

Referring now to FIG. 5B, in some embodiments, the one or more sets of access rules are merged (522) into a traffic configuration (e.g., traffic configuration 418, FIG. 4) that specifies a pricing policy for the requested content, wherein the one or more sets of access rules is a plurality of sets of access rules.

In some embodiments, merging includes (524) determining, in accordance with one or more arbitration rules, a merged pricing policy for each of the one or more content types having respective pricing policies specified by the plurality of sets of access rules. Stated another way, arbitration rules are used to determine a corresponding pricing policy for a given content type when obtained sets of access rules specify multiple (sometimes partially conflicting) pricing policies for the given content type. As an example, a first content type may have a first pricing policy when accessed in a first web-based product (e.g., accessible without payment) and have a second, distinct pricing policy when accessed in a different web-based product (e.g., access requires payment).

In some embodiments, determining the merged pricing policy in accordance with the one or more arbitration rules includes (526) identifying, for a first content type of the one or more content types, a pricing policy that is associated with a lowest cost of access among the pricing policies of the plurality of sets of access rules. The merged pricing policy is the identified pricing policy. For example, if one set of obtained access rules specifies that access to a first content type is allowed without payment and another set of obtained access rules specifies that access to the first content type requires payment at a first price level, the merged pricing policy for the first content type is determined to be the pricing policy where access to the first content type is allowed without payment.

In some embodiments, determining the merged pricing policy in accordance with the one or more arbitration rules includes (528) identifying, for a first content type of the one or more content types, a pricing policy that is associated with a highest cost of access among the pricing policies of the plurality of sets of access rules. The merged pricing policy is the identified pricing policy. For example, if one set of obtained access rules specifies that access to a first content type is allowed without payment, and another set of obtained access rules specifies that access to the first content type requires payment at a first price level, the merged pricing policy for the first content type is determined to be the pricing policy where access to the first content type requires payment at a first price level.

Referring to FIG. 5C, based on the one or more obtained sets of access rules, access to the requested content (e.g., in accordance with a first pricing policy, step 506) is (530) granted or denied. In some embodiments, access (in accordance with a particular pricing policy) is granted or denied based on whether at least one of the one or more obtained sets of access rules specifies a pricing policy for a content type of the requested content, and whether the specified pricing policy is the same or otherwise consistent with a pricing policy associated with the received request (e.g., the first pricing policy, step 506). An example is described with respect to FIG. 4, where a received request includes a URL for accessing content without payment. In the example, however, an obtained set of access rules (e.g., a wallet definition 406) indicates that access to the requested content requires payment (i.e., content is paid, non-zero-rated content). Thus, access to the requested content without payment is denied.

A link is then generated (532) in accordance with the one or more sets of access rules and the access being granted or denied, and the generated link is transmitted (538) to the first network carrier. In some embodiments, the generated link is provided to a user device for access to content in accordance with a corresponding pricing policy.

In some embodiments, the received request includes a first link for accessing the content in the first web-based product in accordance with a first pricing policy (step 506, FIG. 5A). Furthermore, at least one of the one or more sets of access rules specifies (534) the first pricing policy for a content type of the requested content. Access is granted (e.g., since the specified pricing policy and the pricing policy associated with the request are the same), and accordingly the generated link is the first link for accessing the requested content in accordance with the first pricing policy. In other words, the received request includes a URL for accessing content in accordance with a pricing policy that is specified by at least one obtained set of access rules for the first network carrier.

In some embodiments, the received request includes a first link for accessing the content in the first web-based product in accordance with a first pricing policy (step 506, FIG. 5A). Furthermore, at least one of the one or more sets of access rules specifies (536) a second pricing policy distinct from the first pricing policy for a content type of the requested content. Accordingly, the generated link is a second link for accessing the requested content in accordance with the second pricing policy, where the first link and the second link are distinct. In other words, a different link is generated and a user is re-directed if the received request includes a URL for accessing content in accordance with a pricing policy that is not specified by, or partially contradicts, at least one obtained set of access rules for the first network carrier.

For example, in some implementations, a user may be re-directed if the request is for accessing “free” content (e.g., URL for accessing zero-rated content), but the user is ineligible. Here, the first pricing policy (step 506) allows access to the content type of the requested content without payment, and the second pricing policy (step 536) requires payment for access to the content type of the requested content.

Alternatively, in some implementations, a user may be re-directed if the request is for accessing “paid” content (e.g., URL for accessing non-zero-rated content), but the user is eligible for “free” content (e.g., zero-rated content). Here, the first pricing policy (step 506) requires payment for access to the content type of the requested content, and the second pricing policy (step 506) allows access to the content type of the requested content without payment.

As previously described, content is sometimes accessed via native applications (e.g., social network client module 240, FIG. 2,)) that maintain a cache of URLs. In these cases, to prevent situations in which content is accessed in accordance with an ineligible pricing policy by using cached links, rewrite rules may be used to modify cached links to ensure that content is accessed in accordance with proper pricing policies. That is, in some implementations, the server system detects that the received request originated from a native application executing on a client device (e.g., social network client module 240) connected to the first network carrier. In accordance with the detecting, a set of rewrite rules is identified based on the one or more sets of access rules obtained for the first network carrier, wherein a link for accessing content in the first web-based product using the native application is rewritten based on the set of rewrite rules. The set of rewrite rules is then transmitted to the first network carrier. In some implementations, rewrite rules specify predefined characters or strings to convert, and the characters/strings resulting from conversion. For example, where “free.fb.com” corresponds to content access in accordance with a pricing policy that does not require payment, and “paid.fb.com” corresponds to content access in accordance with a pricing policy that requires payment, rewrite rules may specify that the word “free” (in a URL included in a received access request) be replaced with the word “paid,” resulting in a re-written URL: “paid.fb.com.”

For situations in which the systems discussed above collect information about users, the users may be provided with an opportunity to opt in/out of programs or features that may collect personal information (e.g., information about a user's preferences or a user's contributions to social content providers). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a server system having one or more processors and memory storing instructions for execution by the one or more processors:
receiving, from a first network carrier, a request by a user device for accessing content in a first web-based product;
determining an identity of the first network carrier from the received request;
based at least in part on the identity of the first network carrier, obtaining one or more sets of access rules associated with the first network carrier, each of the one or more sets of access rules specifying pricing policies for each of one or more content types;
granting or denying access to the requested content based on the one or more sets of access rules;
generating a link in accordance with the one or more sets of access rules and the access being granted or denied; and
transmitting the generated link to the first network carrier.

2. The method of claim 1, wherein a respective pricing policy of the specified pricing policies is selected from the group consisting of a pricing policy allowing access to a respective content type without payment, a pricing policy requiring payment at a first price level for access to the respective content type, and a pricing policy requiring payment at a second price level that is greater than the first price level for access to the respective content type.

3. The method of claim 1, wherein the one or more sets of access rules is a plurality of sets of access rules, the method further comprising:
merging the plurality of sets of access rules into a traffic configuration that specifies a pricing policy for the requested content, the merging comprising determining, in accordance with one or more arbitration rules, a merged pricing policy for each of the one or more content types having respective pricing policies specified by the plurality of sets of access rules;
wherein generating or denying the access and generating the link are performed in accordance with the traffic configuration.

4. The method of claim 3, wherein determining the merged pricing policy in accordance with the one or more arbitration rules comprises:
for a first content type of the one or more content types, identifying a pricing policy that is associated with a lowest cost of access among the pricing policies of the plurality of sets of access rules;
wherein the merged pricing policy is the identified pricing policy.

5. The method of claim 3, wherein determining the merged pricing policy in accordance with the one or more arbitration rules comprises:
for a first content type of the one or more content types, identifying a pricing policy that is associated with a highest cost of access among the pricing policies of the plurality of sets of access rules;
wherein the merged pricing policy is the identified pricing policy.

6. The method of claim 1, wherein each set of access rules of the one or more sets of access rules further specifies one or more users permitted to access the requested content.

7. The method of claim 6, wherein the one or more sets of access rules include a set of access rules specifying respective pricing policies for a single user.

8. The method of claim 1, wherein each set of access rules of the one or more sets of access rules further specifies a user interface element to display or to refrain from displaying while accessing the first web-based product.

9. The method of claim 8, wherein the user interface element includes an image to display in response to an attempt to access a content type that requires payment.

10. The method of claim 8, wherein the user interface element includes a video banner.

11. The method of claim 1, wherein a first set of access rules of the one or more sets of access rules further specifies an expiration of access to the first web-based product.

12. The method of claim 1, wherein obtaining the one or more sets of access rules is further based on a characteristic of a user of the user device.

13. The method of claim 1, wherein:
the received request includes a first link for accessing the content in the first web-based product in accordance with a first pricing policy;
the generated link is the first link for accessing the requested content in accordance with the first pricing policy; and
at least one of the one or more sets of access rules specifies the first pricing policy for a content type of the requested content.

14. The method of claim 1, wherein:
the received request includes a first link for accessing the content in the first web-based product in accordance with a first pricing policy;
the generated link is a second link for accessing the requested content in accordance with a second pricing policy distinct from the first pricing policy;
at least one of the one or more sets of access rules specifies the second pricing policy for a content type of the requested content; and
the first link and the second link are distinct.

15. The method of claim 14, wherein:
the first pricing policy allows access to the content type of the requested content without payment; and
the second pricing policy requires payment for access to the content type of the requested content.

16. The method of claim 14, wherein:
the first pricing policy requires payment for access to the content type of the requested content; and the second pricing policy allows access to the content type of the requested content without payment.

17. The method of claim 1, further comprising:
detecting that the received request originated from a native application executing on a client device connected to the first network carrier;
in accordance with the detecting, identifying a set of rewrite rules based on the one or more sets of access rules obtained for the first network carrier, wherein a link for accessing content in the first web-based product using the native application is rewritten based on the set of rewrite rules; and
transmitting the set of rewrite rules to the first network carrier.

18. The method of claim 1, wherein the one or more sets of access rules include a set of access rules associated with the first product.

19. A server system, comprising:
a processor; and
memory storing one or more programs for execution by the processor, the one or more programs including instructions for:
receiving, from a first network carrier, a request by a user device for accessing content in a first web-based product;
determining an identity of the first network carrier from the received request;
based at least in part on the identity of the first network carrier, obtaining one or more sets of access rules associated with the first network carrier, each of the one or more sets of access rules specifying pricing policies for each of one or more content types;
granting or denying access to the requested content based on the one or more sets of access rules;
generating a link in accordance with the one or more sets of access rules and the access being granted or denied; and
transmitting the generated link to the first network carrier.

20. A non-transitory computer-readable storage medium storing one or more programs for execution by one or more processors, the one or more programs including instructions for:
receiving, from a first network carrier, a request by a user device for accessing content in a first web-based product;
determining an identity of the first network carrier from the received request;
based at least in part on the identity of the first network carrier, obtaining one or more sets of access rules associated with the first network carrier, each of the one or more sets of access rules specifying pricing policies for each of one or more content types;
granting or denying access to the requested content based on the one or more sets of access rules;
generating a link in accordance with the one or more sets of access rules and the access being granted or denied; and
transmitting the generated link to the first network carrier.
